(19) United States
(12) Patent Application Publication
(10) Pub. No.: US 2004/0140947 A1
(43) Pub. Date: Jul. 22, 2004

(54) Display device

(76) Inventors: Takashi Tsuyuki, Sagamihara (JP); Hiroyuki Takahashi, Funabashi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/704,713

(22) Filed: Nov. 12, 2003

(30) Foreign Application Priority Data
Nov. 15, 2002 (JP) 2002-331668

(51) Int. Cl. G09G 5/00

(52) U.S. Cl. 345/1.1

(57) ABSTRACT

The present invention achieves the suppression of vertical smear and the low power consumption when two display devices which differ in number of signal lines are driven by a common signal line drive circuit. An image display device includes two display devices formed of the first display device PNL1 and the second display device PNL2 which is constituted of signal lines smaller in number than the signal lines of the first display device PNL1. The signal lines which are driven by a common drive circuit DR are used in common by signal lines DLm of the first display device and by signal lines DLs of the second display device. The display of images is alternatively or simultaneously performed using these two display devices PNL1 and PNL2. The images are displayed in an N-line (N being an integer of 1 or more) inversion drive mode when the display is performed on only the first display device PNL1 and when the display is performed on both of the first display device PNL1 and the second display device PNL2, while the images are displayed in a frame inversion drive mode when the display is performed only on the second display device.

### BACKGROUND OF THE INVENTION

The present invention relates to an image display device, and more particularly to an image display device which includes display devices having two display screens of different display data quantities and can perform display of images on respective display devices alternatively or simultaneously.

With respect to a miniaturized equipment such as portable information terminal including a mobile telephone or the like, it is expected that the availability and power saving can be achieved by providing a screen which displays simple information such as indication of time, status information or manipulation information of the equipment apart from a screen for displaying main useful information such as communication information, content information and the like. For example, in a standby state of an equipment having screens on two surfaces of a body thereof such as a folding type portable telephone, by setting only the screen of small size and low power consumption because of a small display data quantity in an operable state and by operating the screen of required display data quantity in transmitting and receiving manipulation of communication information, the low power consumption can be achieved as a whole.

Conventionally, in the image display device of this type having two screens, display devices which constitute respective screens are operated using individual signal drive circuits. However, to incorporate two display devices which are driven independently from each other in the mobile telephone or the like, an inner volume of a limited housing is in short and, at the same time, a circuit which drives driving circuits provided to respective devices in response to using states becomes necessary and hence, the circuit constitution becomes complicated and pushes up a cost.

To cope with such a situation, it may be possible to realize the miniaturization, the reduction of weight and the low power consumption of an equipment to which the image display device is mounted by enabling the common use of a signal line drive circuit. For example, with respect to a liquid crystal display device described in a patent literature 1 (Japanese Unexamined Patent Publication 2001-67049), first and second liquid crystal display panels which differ in the number of signal lines are used as two display devices which differ in display capacities (number of signal lines), wherein the signal lines with a large display capacity are extended to the liquid crystal display panel having the signal lines with a small display capacity to allow the common use of these extended lines whereby respective liquid crystal display panels are driven using a common signal line drive circuit.

### BRIEF SUMMARY OF THE INVENTION

However, in the above-mentioned image display device, since some signal lines of the first display device having the large display capacity are extended and are used in common with the signal lines of the second display device having the small display capacity, the first display device and the second display device differ from each other in line resistance of signal lines, floating capacity, pixel capacity (liquid crystal capacity in case the image display device is a liquid crystal display device) or the like. Accordingly, in performing a display on a display area of the first display device, a so-called vertical smear is generated on a boundary between a display portion of signal lines which are used in common with the second display device and a display portion of other signal lines and hence, the image quality is deteriorated. The solution of this drawback has been one of tasks to be solved heretofore.

Accordingly, it is an object of the present invention to provide an image display device of low power consumption which uses signal lines driven by a common drive circuit which is shared first and second display devices in common and performs display of images alternatively or simultaneously using these two display devices whereby the image display device can realize an image display of high quality by suppressing the generation of above-mentioned vertical smear in the first display device along with the realization of low power consumption.

According to one aspect of the present invention, a liquid crystal display device includes a first display device in which a plurality of first scanning lines and a plurality of first signal lines are arranged in a matrix array on a substrate and a plurality of first pixels having connected first switching elements are formed on intersecting portions of the first scanning lines and the first signal lines, a second display device in which a plurality of second scanning lines and a plurality of second signal lines are arranged in a matrix array on a substrate and a plurality of second pixels having connected second switching elements are formed on intersecting portions of the second scanning lines and the second signal lines, and a display control device which controls display operations of the first display device and the second display device, wherein the number of the second signal lines of the second display device is smaller than the number of the first signal lines of the first display device, the second signal lines of the second display device are connected to the first signal lines of the first display device, the display control device displays images by driving of the first display device in a first display mode, and displays images by driving of the second display device in either one of the first display mode and the second display mode.

According to another aspect of the present invention, in a liquid crystal display device which includes two display devices constituted of a first display device and a second display device which is formed of signal lines smaller in number than signal lines of the first display device, the signal lines which are driven by a common drive circuit are used in common by the first and the second display devices, two display devices alternatively or simultaneously perform an image display, wherein when the image display is performed by only the first display device or when the image displayed is performed by two display devices constituted of the first display device and the second display device, an N-line (N being an integer of 1 or more) inversion drive mode is adopted, and when the image display is performed by only the second display device, a frame inversion drive mode is adopted.

Due to such constitutions, by performing the N-line inversion drive mode, that is, the N-line alternating drive, it is possible to suppress the vertical smear which is generated at the first display device side due to the influences of the pixel capacity, the wiring resistance and the like of the second display device when the display is performed using only the first display device or when the display is performed using the first display device and the second display device. Further, when the display is performed using only the second display device, by changing over the display mode to the frame inversion drive mode, that is, the frame alternating drive, the power consumption can be suppressed.

By integrating the drive circuits for respectively driving the first and the second display devices into one drive circuit, the constitution can be simplified. Further, by changing over the display mode at the second display device which is constituted of the small number of signal lines to the frame inversion drive mode, the low power consumption can be realized.

Here, it is needless to say that the present invention is not limited to the above-mentioned constitution and the constitutions of embodiments described later and various modifications can be made without departing from the technical concept of the present invention, and the present invention is applicable in the same manner to an active matrix type liquid crystal display device and an organic EL display device which use thin film transistors as active elements, and other known image display devices using active elements.

### BRIEF DESCRIPTION OF THE DRAWINGS

FIG. 1 is a plan view for schematically explaining the constitution of one embodiment of an image display device according to the present invention;

FIG. 2 is a waveform chart for explaining main signals outputted from a drive circuit in a frame inversion drive mode in the embodiment of the present invention;

FIG. 3 is a waveform chart for explaining main signals outputted from the drive circuit in an N-line inversion drive mode in the embodiment of the present invention;

FIG. 4 is a block diagram for explaining a constitutional example of a control device in the image display device of the present invention;

FIG. 5 is a plan view for schematically explaining the constitution of another embodiment of the image display device according to the present invention;

FIG. 6 is a plan view for schematically explaining the constitution of another embodiment of the image display device according to the present invention;

FIG. 7 is a plan view for schematically explaining the constitution of another embodiment of the image display device according to the present invention;

FIG. 8 is a developed perspective view for explaining a constitutional example of a liquid crystal display module using the liquid crystal display device according to the present invention; and

FIG. 9 is a plan view for explaining an appearance of a constitutional example of a liquid crystal display module using the liquid crystal display device according to the present invention.

### DESCRIPTION OF THE PREFERRED EMBODIMENTS

Hereinafter, specific embodiments of the present invention are explained in detail in conjunction with drawing showing the embodiments. In the drawings which are referred to in the explanation, parts which have the identical functions are given same reference symbols and the repeated explanation of these parts are omitted as much as possible. Here, the explanation is made by taking a liquid crystal display device using thin film transistors as active elements as an example.

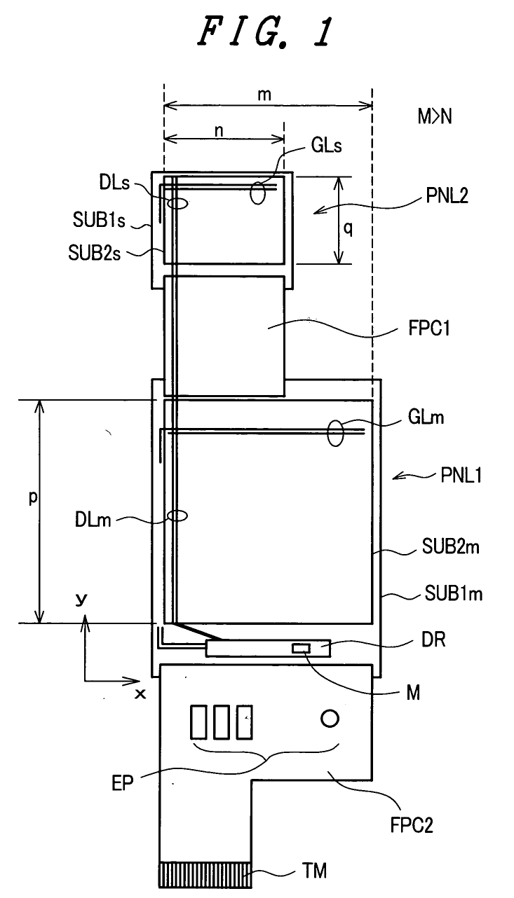

FIG. 1 is a plan view for schematically explaining the constitution of one embodiment of the image display device according to the present invention. In the drawings, reference symbol PNL1 indicates a first display device, wherein the first display device PNL1 is constituted by sandwiching a liquid crystal layer between a first substrate SUB1m and a second substrate SUB2m. On a main surface of the first substrate SUB1m, that is, on an inner surface of the first substrate SUB1m which faces the second substrate SUB2m, a plurality of signal lines (also referred to as data line or drain lines) DLm which extend in the vertical direction (hereinafter referred to as y direction) and are arranged in parallel in the horizontal direction (hereinafter referred to as x direction) are formed. Further, on the main surface of the first substrate SUB1m, that is, on the inner surface of the first substrate SUB1m which faces the second substrate SUB2m, a large number of scanning lines (gate lines) GLm which extend in the x direction and are arranged in parallel in the y direction are formed. Reference symbol PNL2 indicates a second display device, wherein a liquid crystal layer is sandwiched between a first substrate SUB1s and a second substrate SUB2s. On a main surface of the first substrate SUB1s, that is, on an inner surface of the first substrate SUB1s which faces the second substrate SUB2s, a plurality of signal lines (also referred to as data line or drain lines in the same manner as the above) DLs which extend in the y direction and are arranged in parallel in the x direction are formed. These signal lines DLs are connected to some (a plurality of lines arranged at the left side in FIG. 1) of the signal line DLm of the first display device PNL1. The signal lines DLs are formed in a state that the signal lines DLs extend by way of a flexible printed circuit board FPC1. Further, on the main surface of the first substrate SUB1s, that is, on the inner surface of the first substrate SUB1s which faces the second substrate SUB2s, a large number of gate lines GLs which extend in the x direction and are arranged in parallel in the y direction are formed. These gate lines GLs are wired such that they are pulled around the first substrate SUB1m of the first display device PNL1 by way of the flexible printed circuit board FPC1.

The gate lines GLs of the second display device PNL2 and the gate lines GLm of the first display device PNL1 are driven by a scanning line drive circuit incorporated in a drive circuit DR. The number of the gate lines GLs which are provided to the second display device PNL2 is smaller than the number of gate lines GLm which are provided to the first display device PNL1. In this embodiment, although the explanation is made on the premise that the resolutions (definitions) of the first and the second display devices are equal, while a screen size of the second display device PNL2 is smaller than a screen size of the first display device PNL1, there may be a case that the resolution of the second display device is coarse or, to the contrary, there may be a case that the second display device exhibits the finer definition than the first display device.

Here, the number n of the signal lines DLs which are provided to the second display device PNL2 is smaller than the number m of the signal lines DLm which are provided to the first display device PNL1 (n<m). Further, the number q of the gate lines GLs which are provided to the second display device PNL2 is smaller than the number p of the scanning lines GLm which are provided to the first display device PNL1 (q<p). Accordingly, provided that the definition is equal, the display screen size of the second display device PNL2 becomes smaller than the display screen size of the first display device PNL1.

On a side of a portion (lower side in FIG. 1) of the first substrate SUB1m of the first display device PNL1 in the x direction which is not covered with the second substrate SUB2m, a drive circuit (semiconductor chip) DR is mounted. The drive circuit DR incorporates a signal line drive circuit and a scanning line drive circuit in one chip. Further, the drive circuit DR incorporates a frame memory (image memory GRAM)M therein, wherein the frame memory has a capacity corresponding to at least a display capacity of the first display device PNL1. Although the drive circuit DR is mounted using a so-called chip-on-glass (COG) mounting, the drive circuit DR may be directly built in the first substrate SUB1m.

The signal line drive circuit supplies the scanning signals (gate signals) to the scanning lines GLm of the first display device PNL1 and to the scanning lines GLs of the second display device PNL2. That is, the signal line drive circuit has terminals for supplying the gate signals to both of the scanning lines GLm of the first display device PNL1 and to the scanning lines GLs of the second display device PNL2.

In the drive circuit DR, a timing converter which generates timing signals or the like for displaying image data to the first display device PNL1 and the second display device PNL2 in response to various timing signals including image data and clock signals inputted from an external signal source (a host-side CPU or the like) through a flexible printed circuit board FPC2 and an image memory M which stores the image data are incorporated. Here, electronic parts such as resistors, capacitors and the like or a power source circuit (semiconductor chip) EP are mounted on the flexible printed circuit board FPC2.

The first display device PNL1 and the second display device PNL2 are connected by the flexible printed circuit board FPC1 disposed therebetween and the scanning signals and the image signals (gray scale signals) from the drive circuit DR are supplied to the first display device PNL1 and the second display device PNL2. Further, on inner surfaces of the respective second substrates SUB2m, SUB2s of the first display device PNL1 and the second display device PNL2, color filters in three colors (RGB) and common electrodes are formed, wherein a common electrode voltage is applied to the common electrodes. The color filters and the common electrodes are omitted from the drawing.

In the constitution of the embodiment shown in FIG. 1, some of the signal lines DLm in the first display device PNL1 are formed in common with the signal lines DLs of the second display device PNL2 and these lines are driven by the drive circuit DR. The drive circuit DR makes the first display device PNL1 and the second display device PNL2 alternatively or simultaneously perform the display of images. When the images are displayed using only the first display device PNL1, the image display device is driven in an N-line (N being 1 or integer) inversion drive mode (N-line AC drive mode). Further, also when the images are displayed using both of the first display device PNL1 and the second display device PNL2, the image display device is also driven in an N-line inversion drive mode in the same manner. To the contrary, when the images are displayed using only the second display device PNL2, the display is performed in an inversion drive mode (frame alternating drive mode).

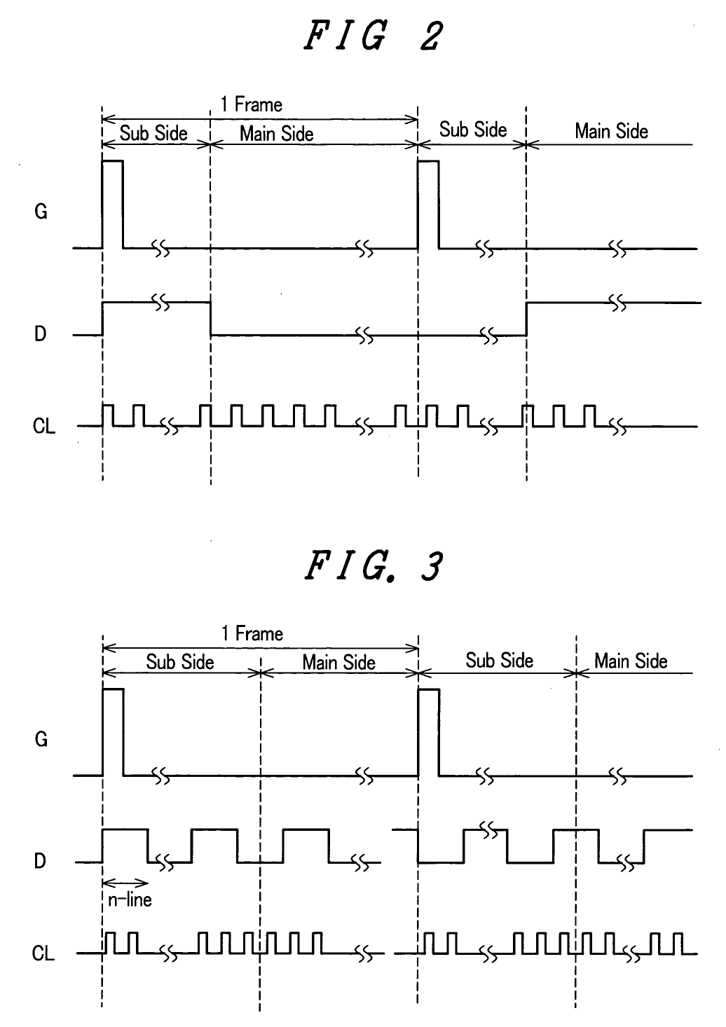

FIG. 2 is a waveform chart for explaining main signals outputted from the drive circuit in the frame inversion drive mode in the embodiment of the present invention. In FIG. 2, a waveform G indicates an output signal to the scanning lines, a waveform D indicates an output signal to the signal lines, and a waveform CL indicates a line clock signal output. In performing the image display on the first display device PNL1 and the second display device PNL2, the output signals D (gray scale voltages) are supplied to the signal lines of the pixels having active elements (thin film transistors or the like, explained as thin film transistors hereinafter) which are connected to the signal lines selected in response to the line clock signal CL in synchronism with the output signal G to the scanning lines. This output signal D is fetched into respective pixels at a pixel clock not shown in the drawing and the image display is performed.

When the image display is performed using only the second display device PNL2, as shown in FIG. 2, in the frame inversion drive mode, one image frame stored in the frame memory M which is incorporated in the drive circuit DR is inverted between a display period (described as a sub side in the drawing) of the second display device PNL2 which is a period corresponding to the number DLs of the signal lines in the second display device PNL2 and a display period (described as a main side in the drawing) of the first display device PNL1 which is a period corresponding to the number DLm of the signal lines in the first display device PNL1. Then, in the next frame, the polarity of the output signal D of the display data is further inverted at the sub side and the main side. Here, the output signal D to the signal lines DLm in the first display device PNL1 is referred to as“black” signal.

Due to such a constitution, when the image display is performed using only the second display device PNL2, by adopting the frame inversion drive mode, that is, the frame alternating drive, the operation of the image display device is set free from the influence of the wiring resistance of the signal lines, the pixel capacity and the like and hence, electric power necessary for the line inversion drive mode can be saved whereby the power consumption can be suppressed.

With respect to the first display device PNL1 and the second display device PNL2, there considered is an embodiment in which the first display device PNL1 and the second display device PNL2 are mounted on an equipment such as a folding-type mobile telephone, a mobile terminal or the like which is mechanically foldable at at least one portion using a bending portion as a boundary. In this case, it is possible to have a state in which only the second display device PNL2 is arranged at a portion where the second display device PNL2 can be observed in a standby state and the first display device PNL1 is also observed during calling or mailing. Also considered is a case in which in a state that the equipment is folded, the second display device PNL2 is driven in the frame inversion mode and, when the equipment is opened to assume a state in which the first display device PNL1 is observed, the first display device PNL1 is driven in the line inversion mode.

FIG. 3 is a waveform chart for explaining the main signals outputted from the drive circuit in the N-line inversion drive mode in the embodiment of the present invention. Reference symbols given to the waveforms in FIG. 3 are substantially equal to the reference symbols used in FIG. 2. In FIG. 3, when the image display is performed using only the first display device PNL1, or when the image display is performed using the first display device PNL1 and the second display device PNL2 simultaneously, the display is performed by inverting the polarity for every N-lines at the sub side and the main side. Here, N is 1 or more and is equal to or smaller than the number of signal lines DLs in the second display device PNL2. In an actual operation, it is preferable to set N to 1 line to several lines.

By adopting such drive modes, it is possible to suppress the vertical smear which is generated at a boundary between the signal line which is used in common with the second display device PNL2 and other signal line on the screen at the first display device PNL1 side due to the influence of the wiring resistance, the pixel capacity and the like of the second display device PNL2 whereby the image display of high quality can be realized.

Command signals for making the above-mentioned first display device PNL1 and second display device PNL2 selectively display the image are configured such that, for example, when the present invention is applied to a screen-portion foldable mobile telephone having two screens, a switch which detects opening/closing of the screen portion is provided, a display mode selection signal which allows only the second display mode to perform the display in a state that the screen portion is folded is generated, and a signal which allows the first display device and the second display device perform the display of different images simultaneously in a state that the screen portion is opened is generated. Here, the display data to be displayed on the first display device PNL1 and the second display device PNL2 may be stored such that a region of a frame memory is divided corresponding to the above-mentioned first display device PNL1 and second display device PNL2 or a memory which stores display data to be displayed on the second display device PNL2 may be provided separately from the frame memory.

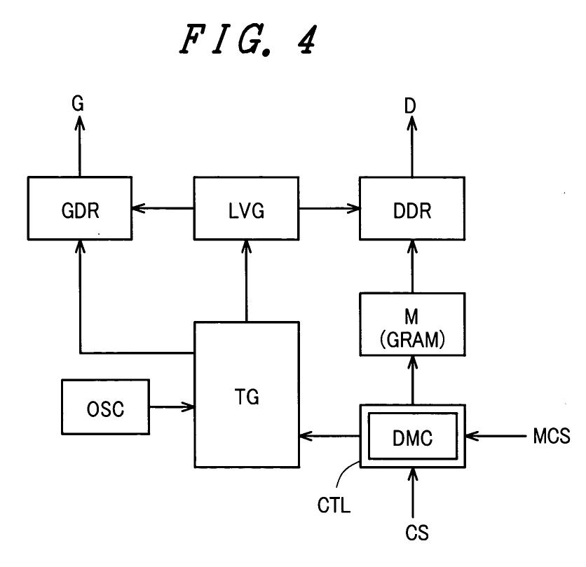

FIG. 4 is a block diagram for explaining a constitutional example of a control device in the image display device according to the present invention. In FIG. 4, reference symbol CTL indicates a display control device. The display control device CTL incorporates a display mode control circuit DMC therein and controls the display of the image display device by receiving various types of signals CS such as display data from a central processing unit (CPU) which constitutes a system of an equipment to which the image display device is applied and various types of timing signals including the reference clock as inputs. Reference symbol M indicates a graphic memory (GRAM: frame memory) and stores the display data from the central processing unit (CPU) therein. Reference symbol TG indicates a timing generating circuit which generates various types of timings necessary for the display using the first display device and the second display device based on the reference clock or the like inputted from the central processing unit (CPU) based on a reference frequency signal generated by an oscillation circuit OSC, LVG indicates a voltage generating circuit for driving liquid crystal, GDR indicates a scanning line drive circuit, and DDR indicates a signal line drive circuit. Further, the reference signal G indicates a scanning line drive voltage output and reference symbol D indicates a signal line drive voltage output and these outputs correspond to waveforms indicated by the same symbols in FIG. 2 and FIG. 3.

The display mode selection signal MCS, in the above-mentioned state in which the screen portion is folded, gives the command signals for driving the second display device in the frame inversion mode explained in conjunction with FIG. 2 to the display mode control circuit DMC. Further, when the image is displayed using only the first display device or when the image is displayed using the first display device and the second display device simultaneously in a state that the screen portion is opened, the line inversion mode is selected. On the other hand, when the image is displayed using only the first display device in a state that the screen portion is opened, this display can be realized by supplying“black” signal to the second display device or by separately providing a switch which stops the display of the second display device or the like.

Here, the display mode selection signal MCS maybe inputted to the central processing unit (CPU) and this display mode selection signal is also given to the display control device CTL as some of various signals CS.

The display mode control circuit DMC sets a read-out address of the graphic memory M upon receiving the display mode selection signal MCS and outputs the display data corresponding to respective display modes to the signal line drive circuit DDR. On the other hand, the display mode control circuit DMC generates the timing signal in the frame inversion mode or the line inversion mode in the timing generating circuit TG in accordance with the selected display mode and gives a voltage level in the corresponding display mode to the scanning line drive circuit GDR and the voltage generating circuit LVG. The signal line drive circuit DDR supplies a given display voltage to the signal lines in response to the display data from the graphic memory GRAM and the voltage level from the voltage generating circuit LVG. Further, the scanning line drive circuit GDR supplies a given scanning voltage to the scanning lines in response to the timing signal from the timing generating circuit TG and the voltage level from the voltage generating circuit LVG.

In this manner, according to this embodiment, by integrating the signal line drive circuits for driving the first and the second display devices respectively into one signal line drive circuit, the constitution can be simplified. Further, by adopting the frame inversion drive mode as the display mode in the second display device which is constituted with the small number of signal lines, the low power consumption can be realized.

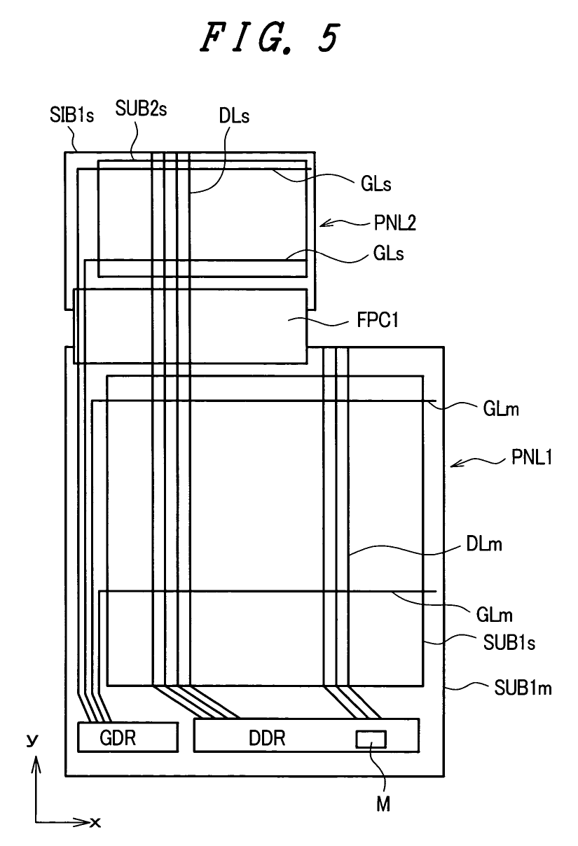

FIG. 5 is a plan view for schematically explaining the constitution of another embodiment of the image display device according to the present invention. In the drawing, reference symbols equal to those symbols in FIG. 1 correspond to identical functional portions. In the image display device explained in conjunction with FIG. 1, the scanning line drive circuit GDR is incorporated in the semiconductor chip in which the signal line drive circuit DDR is also incorporated. In this embodiment, however, the scanning line drive circuit GDR is mounted on the first substrate SUB1m of the first display device PNL1 as an independent semiconductor chip such that the scanning line drive circuit GDR is arranged parallel to the signal line drive circuit DDR. The scanning lines from the scanning line drive circuit GDR are pulled around along one side in the y direction of the first substrate SUB1m of the first display device PNL1 and, thereafter, are pulled around along one side in the y direction of the first substrate SUB1s of the second display device PNL2 by way of the flexible printed circuit board FPC1. Since other constitutions and the manner of operations are equal to those of the previous embodiments, the repeated explanation is omitted.

Also in this embodiment, by integrating the signal line drive circuits for driving the first and the second display devices respectively into one signal line drive circuit, the constitution can be simplified. Further, by adopting the frame inversion drive mode as the display mode in the second display device which is constituted with the small number of signal lines, the low power consumption can be realized.

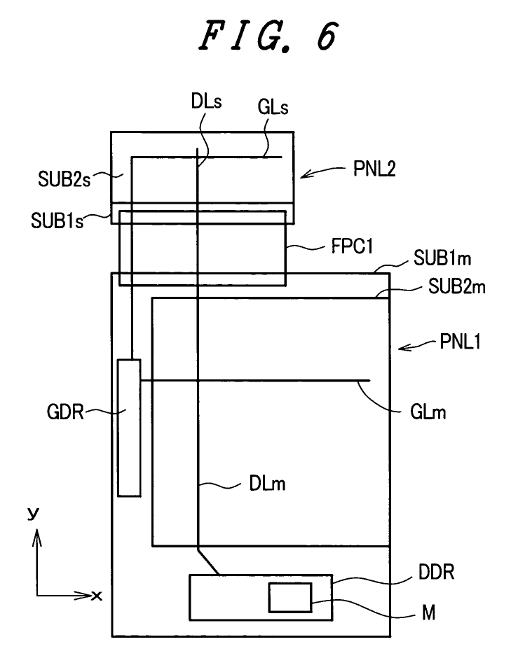

FIG. 6 is a plan view for schematically explaining the constitution of another embodiment of the image display device according to the present invention. In the drawing, reference symbols equal to those symbols in FIG. 1 correspond to identical functional portions. In this embodiment, the scanning line drive circuit GDR in FIG. 5 is mounted on one side in the y direction of the first substrate SUB1m which constitutes the first display device PNL1. The scanning lines from the scanning line drive circuit GDR are pulled around along one side in the y direction of the first substrate SUB1m of the first display device PNL1 and, thereafter, are pulled around along one side in the y direction of the first substrate SUB1s of the second display device PNL2 by way of the flexible printed circuit board FPC1. Since other constitutions and the manner of operations are equal to those of the previous embodiments, the repeated explanation is omitted.

Also in this embodiment, by integrating the signal line drive circuits for driving the first and the second display devices respectively into one signal line drive circuit, the constitution can be simplified. Further, by adopting the frame inversion drive mode as the display mode in the second display device which is constituted with the small number of signal lines, the low power consumption can be realized.

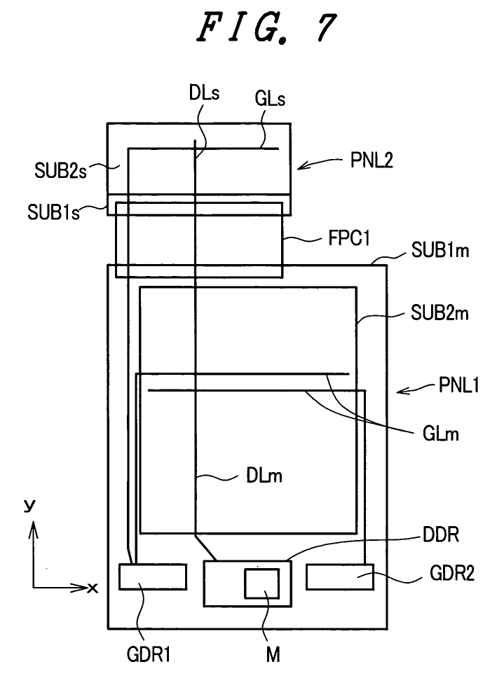

FIG. 7 is a plan view for schematically explaining the constitution of another embodiment of the image display device according to the present invention. In the drawing, reference symbols equal to those symbols in FIG. 1 correspond to identical functional portions. In this embodiment, the scanning line drive circuit GDR is divided into two driving circuits consisting of a first scanning line drive circuit GDR1 and a second scanning line drive circuit GDR2, wherein these drive circuits are mounted on two opposing sides in the y direction of the first substrate SUB1m which constitutes the first display device PNL1. With respect to the first display device PNL1, the scanning lines from the first scanning line drive circuit GDR1 are pulled around along one side in the y direction of the first substrate SUB1m of the first display device PNL1, while the scanning lines from the second scanning line drive circuit GDR2 are pulled around along another side in the y direction of the first substrate SUB1m of the first display device PNL1. The scanning lines on the first display device PNL1 are formed alternately within the display region.

Further, the scanning lines provided to the second display device PNL2 are extended from the first scanning line drive circuit GDR1 and are pulled around one side in the y direction of the first substrate SUB1s of the second display device PNL2 by way of the flexible printed circuit board FPC1. Since other constitutions and the manner of operations are equal to those of the previous embodiments, the repeated explanation is omitted.

According to this embodiment, by integrating the signal line drive circuits for driving the first and the second display devices respectively into one signal line drive circuit, the constitution can be simplified. Further, by adopting the frame inversion drive mode as the display mode in the second display device which is constituted with the small number of signal lines, the low power consumption can be realized. Still further, since the display region of the first display device PNL1 can be arranged at the center of the first substrate SUB1m, mounting of the display region to the center of the display part of an equipment to which the liquid crystal display device of the present invention is applied can be facilitated.

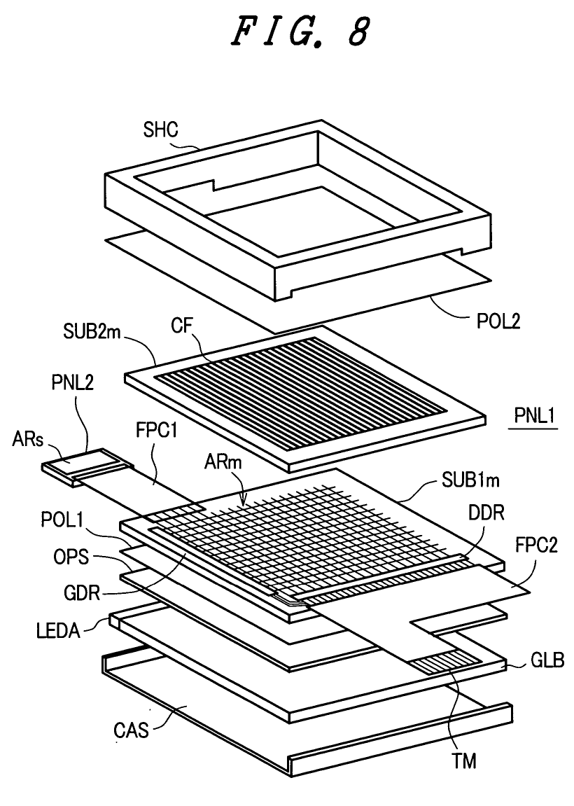

FIG. 8 is a developed perspective view for explaining a constitutional example of a liquid crystal display module which uses the liquid crystal display device according to the present invention.

The liquid crystal display device used in this liquid crystal display module corresponds to the liquid crystal display device which is explained in conjunction with FIG. 6. In FIG. 8, on the first substrate SUB1m of the first display device PNL1, a main display region ARm which is constituted of a plurality of pixels having thin film transistors connected to intersecting portions of the scanning lines and signal lines is formed. Further, the scanning signal line drive circuit GDR and the signal line drive circuit DDR are formed on the first substrate SUB1m. On a main surface (inner surface) of the second substrate SUB2m of the first display device PNL1, color filters CF and common electrodes (not shown in the drawing) are formed. Then, a liquid crystal layer is sealed between the first substrate SUB1m and the second substrate SUB1s. Further, a first polarizer POLL and an optical compensation sheet OPS which is constituted of a diffusion sheet or a prism sheet are mounted on a back surface of the first substrate SUB1m. Further, a polarizer POL2 is also mounted on an upper surface of the second substrate SUB2m.

The above-mentioned scanning line drive circuit GDR and signal line drive circuit DDR are mounted on peripheral sides of the first substrate SUB1m, one end of the flexible printed circuit board FPC2 is connected to the side of the first substrate SUB1m on which the signal line drive circuit DDR is mounted, and other terminal TM is connected to an external signal source (central processing unit or the like) not shown in the drawing. On a back surface of the optical compensation sheet OPS, an illumination device (backlight) which is constituted of a light source such as a light emitting diode LEDA or the like and a light guide plate GLB is arranged. These constitutional elements are integrally formed with a lower casing CAS and an upper casing SHC thus constituting the liquid crystal display module.

On the other hand, the second display device PNL2 is connected to one side of the first display device PNL1 by way of the flexible printed circuit board FPC1. The structure of the second display device PNL2 is substantially equal to the structure of the main panel PNL1, wherein a plurality of pixels having thin film transistors are provided to intersecting portions of the scanning lines and the signal lines thus forming a sub display region ARs. This second display device PNL2 may not be provided with the full color display which is provided to the first display device and the monochromatic display may be provided to the second display device PNL2. Further, the scanning lines and the signal lines are constituted as explained in conjunction with the above-mentioned embodiments. Although the liquid crystal display module having such a constitution can be used as display means of a mobile telephone or a portable information terminal, the liquid crystal display module is applicable to any electronic equipment having a so-called two screen display.

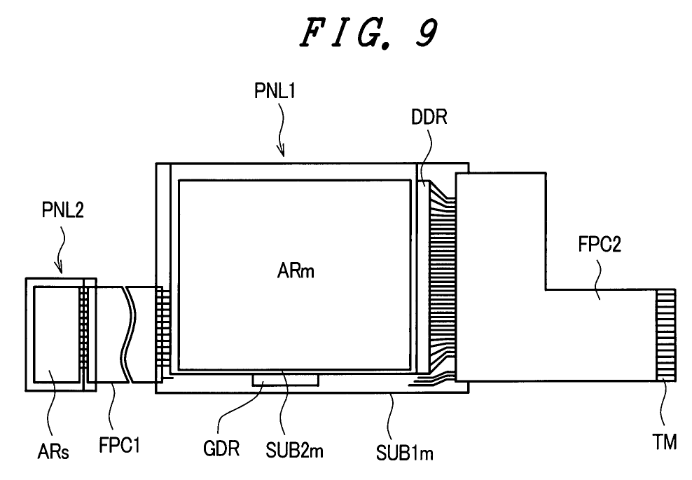

FIG. 9 is a plan view for explaining an appearance of a constitutional example of the liquid crystal display module which uses the liquid crystal display device according to the present invention and shows a state in which the liquid crystal display module in a developed form as explained in conjunction with FIG. 8 is assembled. The first display device PNL1 is formed of the first substrate SUB1m and the second substrate SUB2m and the scanning line drive circuit GDR and the signal line drive circuit DDR which are constituted of the semiconductor chips are mounted on the periphery of the main display region ARm. Electronic components such as HA resisters, capacitors and the like and a power source circuit chip may be mounted on the flexible printed circuit board FPC2.

The second display device PNL2 is connected to the first display device PNL1 by way of the flexible printed circuit board FPC1 as explained in conjunction with the above-mentioned embodiments. The second display device PNL2 can be used such that, for example, the second display device PNL2 is used for simple data display such as a standby display, a clock display or a mail reception display in a mobile telephone which uses the first display device PNL1 as a main display screen. In the above-mentioned embodiments, the signal lines of the second display device which are small in number are used as extensions of a portion which is offset at one side of an integral region of the first display device. However, the present invention is not limited to such an arrangement and the signal lines which are disposed at a region located at the center portion of the first display device may be extended to the second display device. Further, it is possible to provide the image display device having the two screen displays by forming the first display device and the second display device on the same substrate. In this case, the flexible printed circuit board which connects two display devices in respective embodiments becomes unnecessary.

Although the explanation has been made using the liquid crystal display device as an example in the above-mentioned embodiments, the present invention is not limited to the liquid crystal display device and is applicable to an organic EL display device which displays images using a pixel selection method similar to the pixel selection method of the liquid crystal display device and other active matrix type display device.

As has been explained heretofore, according to the present invention, in the image display device which drives two display devices which differ in the number of signal lines using the common drive circuit, it is possible to suppress the vertical smear which is generated on the display device having the larger number of signal lines when two display devices perform the display of images alternatively or simultaneously, whereby it is possible to provide the image display device which enables the image display of high quality and realizes the low power consumption.

What is claimed is:

1. An image display device comprising:
a first display device in which a plurality of first scanning lines and a plurality of first signal lines are arranged in a matrix array on a substrate and a plurality of first pixels having first switching elements are formed on intersecting portions of the first scanning lines and the first signal lines;
a second display device in which a plurality of second scanning lines and a plurality of second signal lines are arranged in a matrix array on a substrate and a plurality of second pixels having second switching elements are formed on intersecting portions of the second scanning lines and the second signal lines; and
a display control device which controls display operations of the first display device and the second display device, wherein the number of the second signal lines of the second display device is smaller than the number of the first signal lines of the first display device,
the second signal lines of the second display device are connected to the first signal lines of the first display device, the display control device displays images by driving the first display device in a first display mode, and
the display control device displays images by driving the second display device in either one of the first display mode and a second display mode.

2. An image display device according to claim 1, wherein the first display mode is a line inversion mode and a second display mode is a frame inversion mode.

3. An image display device according to claim 2, wherein the display control device drives the first display device in the line inversion mode when the image is displayed on the first display device and drives the second display device in the frame inversion mode when the image is displayed on only the second display device.

4. An image display device according to claim 3, wherein the display control device drives both of the first and the second display devices in the line inversion mode when the image is displayed on both of the first display device and the second display device.

5. An image display device according to claim 1, wherein the display control device includes a display mode control circuit, and the display modes are controlled by the display mode control circuit.

6. An image display device according to any one of claims 1 to 5, wherein the display control device includes an image memory having display data capacity which is displayed on at least the first display device.

7. An image display device according to claim 1, wherein the first display device and the second display device are mounted on an equipment which is mechanically foldable at least at a portion thereof, the first panel and the second panel are arranged using the folding portion as a boundary between the first panel and the second panel, the first panel is arranged at a portion which is not observed in a state that the equipment is folded, and the second panel is arranged at a portion which is observed in a state that the equipment is folded,

8. An image display device according to claim 7, wherein the second panel is driven in the frame inversion mode in a state that the equipment is folded.

9. An image display device according to claim 7, wherein the first panel is driven in a line inversion mode when the equipment is opened to assume a state in which the first panel is observed.

10. An image display device comprising:
a first display panel having a substrate on which a plurality of first scanning lines which extend in the first direction and are arranged in parallel in the second direction which intersects the first direction and a plurality of first signal lines which extend in the second direction and are arranged in parallel in the first direction are formed;
a second display panel having a substrate on which a plurality of second scanning lines which extend in the first direction and are arranged in parallel in the second direction, the second scanning lines being smaller than the first scanning lines in number, and a plurality of second signal lines which extend in the second direction and are arranged in parallel in the first direction, the second signal lines being connected to the first signal lines and being smaller than the first signal lines in number are formed;
a scanning line drive circuit capable of supplying scanning signals to the first scanning lines and the second scanning lines;
a signal line drive circuit capable of supplying signals to the first signal lines and the second signal lines;
an image memory having at least a display data capacity to be displayed on the first display panel; and
a display control device which controls display operations of the first display panel and the second display panel, wherein the display control device drives the first display panel in a first mode when images are displayed only on the first display panel and drives the second display panel in a second mode when images are displayed only on the second display panel, and the display control device drives both of the first display panel and the second display panel in the first mode when images are displayed on both of the first display panel and the second display panel.

11. An image display device according to claim 10, wherein the first mode is a line inversion mode and the second mode is a frame inversion mode.

12. An image display device according to claim 10 or claim 11, wherein the display control device includes a display mode control circuit and a control of the display modes is performed by the display mode control circuit.

13. An image display device comprising a first panel and a second panel, wherein
the first panel includes a plurality of signal lines and a plurality of scanning lines which are arranged to intersect the plurality of signal lines, the second panel includes a plurality of signal lines and a plurality of scanning lines which are arranged to intersect the plurality of signal lines,
at least two signal lines are electrically extended out of the plurality of signal lines of the first panel and the second panel and are arranged on the respective panels,
the number of the signal lines of the second panel is smaller than the number of the signal lines of the first panel,
the first panel is driven in one mode, and
the second panel is capable of being driven by another mode in addition to the mode for the first panel.

14. An image display device according to claim 13, wherein one mode is a line inversion mode and another mode is a frame inversion mode.
